(19) United States
(12) Patent Application Publication
(10) Pub. No.: US 2024/0407321 A1
(43) Pub. Date: Dec. 12, 2024

(54) Lift to Sift Litter Box

(71) Applicant: Kenneth Lewis Taylor, JR., Dry Ridge, KY (US)

(72) Inventor: Kenneth Lewis Taylor, JR., Dry Ridge, KY (US)

(21) Appl. No.: 18/208,829

(22) Filed: Jun. 12, 2023

(51) Int. Cl. A01K 1/01

(52) U.S. Cl. CPC A01K 1/0114

(57) ABSTRACT

A tiered detachable sieving litter box, platform, and removable clean sifted litter container are utilized to more efficiently separate waste than conventional litter boxes. The sieving litter box is elevated above the clean sifted litter container on the platform and rotates upon a pivot point on the platform when lifted by hand from the opposing side. The litter then pours through slots built into the side of the litter box sifting the waste and allowing clean litter to flow into the clean sifted container staged below the platform. Waste remaining in the empty litter box can be disposed of by detaching the litter box from the platform. Once the litter box is returned to the top of the platform empty, sifted clean litter from the clean sifter litter container can be poured back into the litter box by picking up the clean sifted litter container and pouring it into the litter box. The clean sifted litter container is then placed back under the platform to reuse.

### FIELD OF INVENTION

There are many variations of litter boxes on the market, most of which either require manual scooping of waste, mechanical means of separation, or impractical sieving of the litter from the waste.

This invention minimizes the risk of mechanical failure while creating a more efficient sieving process.

### BACKGROUND OF INVENTION

As with any pet ownership, cleaning up their waste is an essential part of the responsibility. Current processes for removing waste from litter involve repetitive motion of sifting the litter using a hand scoop which is limited by the size of the scoop. Consecutively, high end automated litter boxes are subject to malfunctions due to the dust that litter creates when being sifted. Despite being expensive these high-end litter boxes can cause frustration when they break down and force the pet owner back to the primitive means of hand scooping the waste. Both of these methods create downtime that take away from the joys of pet ownership. This invention targets to minimize these risks of automated breakdown and create a method of waste management that removes the manual scoop permanently from the industry by innovating the process of waste sifting and disposal.

### BRIEF DESCRIPTION OF THE DRAWINGS

FIG. 1 Is an isometric view of the present invention.

FIG. 2 Is a process view of the litter box rotating about the pivot point allowing litter to flow through the sieve.

FIG. 3 Is a process view that shows the dumping of waste from the litter box into a trash receptacle.

FIG. 4 Is a process view of the sifted clean litter container being removed from under the platform.

FIG. 5 Is a process view of the sifted clean litter container being poured into the empty litter box.

### DESCRIPTION

The drawings and descriptions of said drawings wherein are outlined in this section to define the function and purpose of this invention. These drawings and descriptions are not to limit the scope of the present invention.

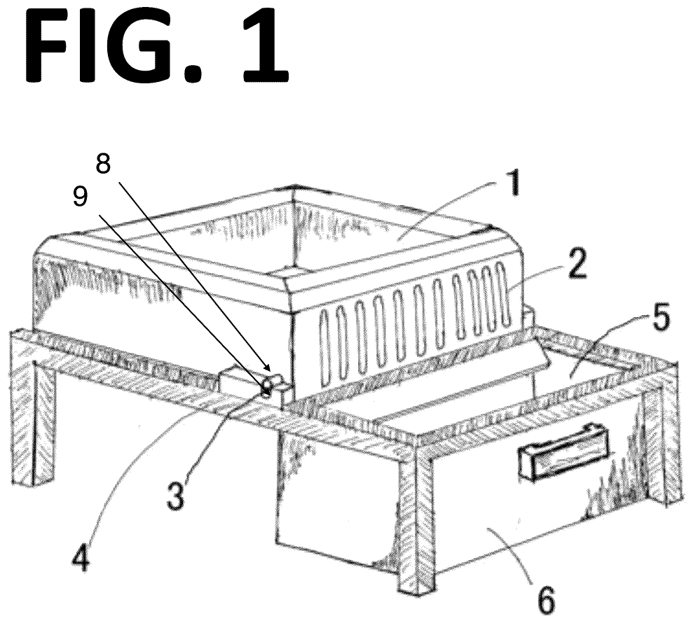

The purpose of this present invention is to minimize the amount of time needed to separate animal waste from litter within a litter box by using means that do not require automated mechanical assistance, nor any type of scoop. Typically, even if the scoop to remove waste is built into a separate process other than a hand scoop, the waste removal is limited to the size and shape of the scoop. This present invention innovates the sifting process by integrating sifting slots (2)—FIG. 1 in the side of the litter box so that the size of the scoop is not limited smaller than the box itself. Furthermore, the size of the sifted clean litter container is calculated such that it can hold the entire contents of litter within the litter box.

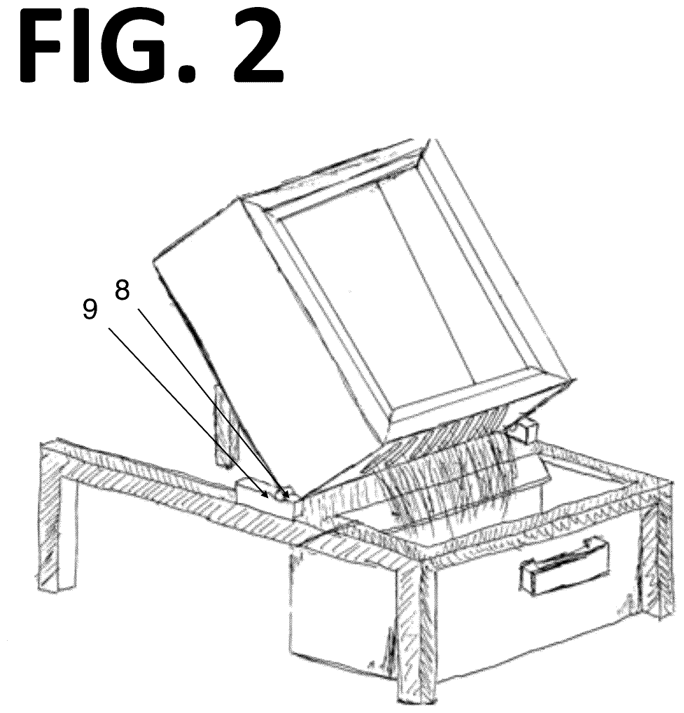

In reference to FIG. 1 In the process of sifting pet waste from the litter contained in the litter box (1), the side of the litter box opposing the sifting slots (2) is lifted until the litter and waste mixture slides towards the sifting slots. The litter box (1) will pivot along a pivot point (3) created between protrusions 8 on sides the litter box are received into receptacles 9 on the side of the platform (4). Clean litter will then pass through the sifting slots then passing through a hole within the platform (5) and enter the sifted clean litter container (6). Note: this design shows the litter passing through a hole, but variations of the design would allow the litter to in any way from above the platform to below the platform. FIG. 2 shows this process described above.

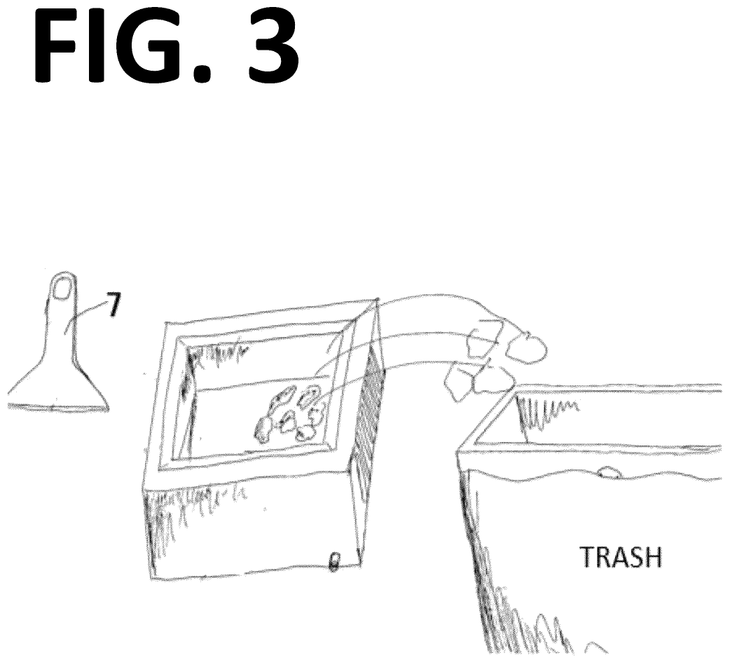

Once the litter has passed from the litter box (1) into the sifted clean litter container (6) the pet waste remains inside the litter box (1) this litter box full of pet waste can be easily removed by simply lifting it from the pivot point (3). Once lifted, the litter box can be taken to the trash and dumped in to empty the waste. As with any cat litter box, tough waste that has stuck to the bottom of the box may need to be removed by using a scraper (7) FIG. 3. When all the waste has been removed the empty litter box (1) can be placed back onto the pivot nests on the platform.

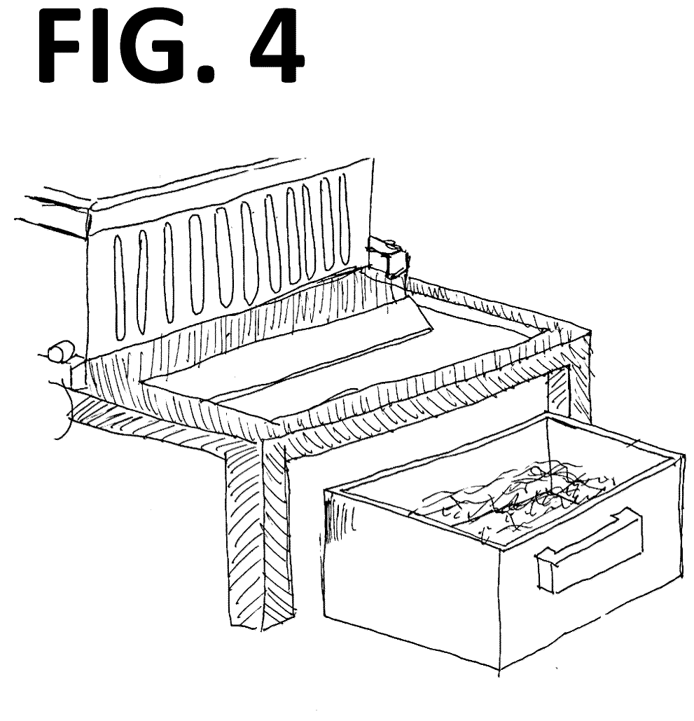

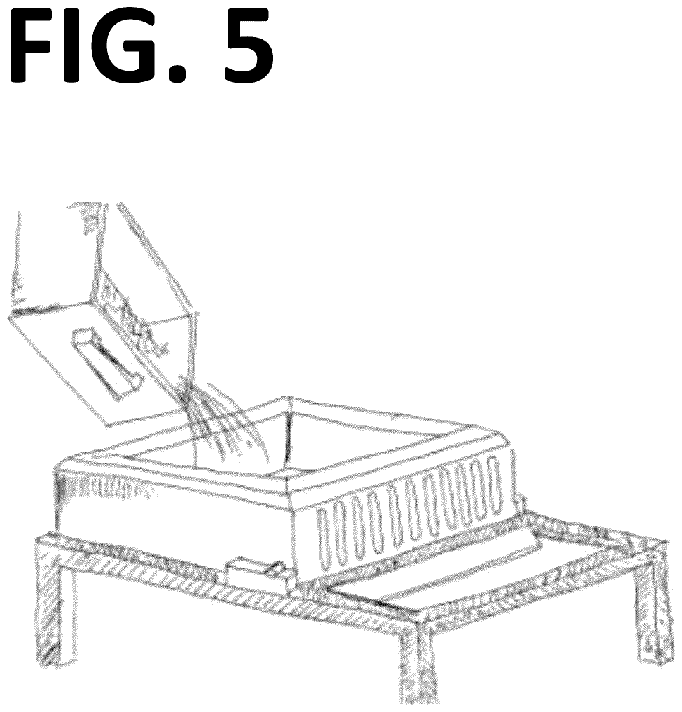

Next the sifted clean litter container (6) can be pulled out from underneath the platform FIG. 4. This sifted clean litter container contains the sifted clean litter from the previous steps. This container can now be taken and dumped into the litter box (1) to replenish the litter in the litter box. This process is seen in FIG. 5. After dumping the litter into the litter box, the sifted clean litter container (6) can be placed underneath the platform (4) to prepare the litter box assembly for re-use.

1. A sifting litter box comprising:
a litter box with at least one side comprising a plurality of sifting slots positioned along a length of the at least one side;
a platform supporting the litter box;
a pivot point between the litter box and the platform; and
a sifted clean litter container positioned beneath the platform; wherein the litter box is designed to pivot on the platform, allowing litter to pass through the plurality of sifting slots and into the sifted clean litter container, separating waste from clean litter.

2. The litter box of claim 1, wherein the platform includes an opening aligned with the plurality of sifting slots to allow the litter to pass through to the sifted clean litter container.

3. The litter box of claim 1, wherein the sifted clean litter container is sized to hold an entirety of the litter from the litter box.

4. The litter box of claim 1 further comprising: a scraper for removing stuck waste from the litter box.

5. (canceled)

6. (canceled)

7. (canceled)

8. A sifting litter box comprising:
a litter box with at least one side comprising a plurality of sifting slots, wherein the litter box has protrusions on a second side and third side;
a platform supporting the litter box wherein the platform has receptacles to removably receive the protrusions of the litter box creating a pivot point; and
a sifted clean litter container positioned beneath the platform; wherein the litter box is designed to pivot on the platform, allowing litter to pass through the plurality of sifting slots and into the sifted clean litter container, separating waste from clean litter.

9. A sifting litter box comprising:
a litter box with at least one side comprising a plurality of sifting slots positioned along a length of the at least one side, wherein the at least one side is a straight surface;
a platform supporting the litter box;
a pivot point between the litter box and the platform; and
a sifted clean litter container positioned beneath the platform; wherein the litter box is designed to pivot on the platform, allowing litter to pass through the plurality of sifting slots and into the sifted clean litter container, separating waste from clean litter.

10. The sifting litter box of claim 9, wherein the plurality of sifting slots are elongated and in a parallel configuration,
